(19) United States
(12) Patent Application Publication
(10) Pub. No.: US 2010/0242782 A1
(43) Pub. Date: Sep. 30, 2010

(54) TRANSPORTATION SYSTEM

(76) Inventor: Robert W. Pollack, Chappaqua, NY (US)

Correspondence Address: EDWARDS ANGELL PALMER & DODGE LLP, P.O. BOX 55874, BOSTON, MA, 02205, US

(21) Appl. No.: 12/749,358

(22) Filed: Mar. 29, 2010

Related U.S. Application Data
(60) Provisional application No. 61/164,424, filed on Mar. 29, 2009.

(51) Int. Cl. B61K 1/00; G05D 1/00

(52) U.S. Cl. 104/20; 701/19

(57) ABSTRACT

The disclosure includes systems and methods of mass transit. In accordance with one embodiment, the system includes a first train traveling on a first track having a first car with a first door for accessing the first car, a second train traveling on a second track parallel to the first track having a second car with a second door for accessing the second car, and a controller for aligning the first and second doors when the first and second trains are traveling alongside one another and engaging the first train to the second train so that passengers or goods can be transferred between the trains while the trains are moving.

### CROSS-REFERENCE TO RELATED APPLICATIONS

This patent application claims priority to U.S. Provisional Patent Application Ser. No. 61/164,424, filed Mar. 29, 2009. The aforementioned patent application is incorporated by reference herein in its entirety.

### BACKGROUND OF THE DISCLOSURE

1. Field of the Invention

The present disclosure relates to improved systems and methods of conveyance of individuals. Particularly, the present disclosure is directed to improved systems and methods of mass transit.

2. Description of Related Art

Commuters utilizing mass transit, particularly those who daily traverse urban areas, spend a good deal of time in non-productive pursuits, reading books and newspapers, playing games and doing puzzles and napping in order to pass the time it takes to get from home to their place of employment.

With urban congestion and pollution caused by vehicles carrying one or more passengers, grid lock, the scarcity of parking and the costs associated with these issues, mass transit is ever more important and attractive to the commuting public. Many commuters are faced, daily, with protracted and uncomfortable repetitions of the previous day's trip, only to endure the same abuse at the end of each work day. In addition to the foregoing needs, there is also a need for a mass transit system that can be more energy efficient than previous systems. The methods and systems of the present disclosure provide solutions for these and other needs, as described herein.

### SUMMARY OF THE DISCLOSURE

The purpose and advantages of the present disclosure will be set forth in and become apparent from the description that follows. Additional advantages of embodiments of the invention will be realized and attained by the methods and systems particularly pointed out in the written description hereof, as well as from the appended drawings.

To achieve these and other advantages and in accordance with the purpose of the disclosure, as embodied herein, the disclosure includes systems and methods of mass transit. In accordance with one embodiment, the system includes a first train traveling on a first track having a first car with a first door for accessing the first car, a second train traveling on a second track parallel to the first track having a second car with a second door for accessing the second car, and a controller for aligning the first and second doors when the first and second trains are traveling alongside one another and engaging the first train to the second train so that passengers or goods can be transferred between the trains while the trains are moving.

In accordance with a preferred embodiment, the transit system is a mass transit system principally for transporting passengers. Preferably, the first train engages the second train to permit transfer between the trains for a predetermined period of time. In a preferred embodiment, the first train is a local train and the second train is an express train. If desired, the second train can travel in a continuous loop and generally does not stop. If desired, each of the first and second trains can be on standard width track. Alternatively, the first and second trains can be on tracks that have a narrower than standard width. To accommodate stability issues, at least one overhead rail can be provided for engaging at least one of the first train and second train. In accordance with a preferred embodiment, a machine readable program on a computer readable medium can be provided containing instructions for controlling the controller.

In accordance with another aspect, a machine readable program on a computer readable medium is provided containing instructions for controlling a system for mass transit. The program includes a first computer code segment for controlling a first train traveling on a first track having a first car with a first door for accessing the first car, a second computer code segment for controlling a second train traveling on a second track parallel to the first track having a second car with a second door for accessing the second car, and a third computer code segment for controlling a controller for aligning the first and second doors when the first and second trains are traveling alongside one another and engaging the first train to the second train so that passengers or goods can be transferred between the trains while the trains are moving. The program is preferably adapted and configured to instruct the first train to engage the second train to permit transfer between the trains for a predetermined period of time.

In accordance with an exemplary embodiment, a system and method are provided whereby an individual such as a commuter may enter a train station and board a local train, which can stop at each station on that particular train line. After the train acquires full speed, for example, sixty miles an hour, it pulls along-side an “express” train (such as an express train traveling in a continuous loop at a substantially continuous speed in the region) going at the same speed. A signal, such as a voice on an intercom, instructs the individual and others, as applicable, that if they wish to board the “express” train, they will have a predetermined period of time (e.g., 30 seconds) in order to do so. The two trains align and mechanical and/or electromagnetic locks join the two trains for the duration of the transfer. Commuters wishing to go long distances non-stop, cross over through doors which are aligned and secured. At a certain moment in the process, passengers are warned to clear the doors and the doors close. Passengers wishing to go only one or two stations remain on the “local” train. The trains separate and eventually the “local” train begins to decelerate into the next station. In contrast, passengers of the “express” train prepare to ride non-stop until the intercom alerts them to prepare to transfer back to a “local” train which will then pull alongside for the transfer.

While on the “express” train, in accordance with a preferred embodiment, the passengers do not experience a substantial deceleration or stopping of their train. The commute is substantially non-stop at top speed from initiation of the trip to its completion. Transfers between different train lines could be accomplished in the same way, for example, in New York City, from the IRT line to the IND line, or from the Lexington Avenue line to the Broadway line.

In accordance with one embodiment, the express line or loop is employed in new mass transit systems being constructed to permit stations to be located at optimum distances to permit sufficient time for the exchange of passengers at desired travel speeds. Preferably, computers and/or transit personnel can control phasing of trains and operating speeds, as well as the dissemination of commuter information over the intercom or other suitable means of communication.

In accordance with another embodiment, the express train (such as an express loop) can be used in new or existing tunnels under ground, on new or existing ground level systems, new or existing elevated systems, on standard or altered gauge railroad track, monorail systems or new support and propulsion systems such as Mag-Lev systems using linear induction (i.e., magnetic attraction and repulsion-based) propulsion systems. A general reference to “tracks” of the claims herein is intended to encompass all such embodiments.

The advantages to such methods and systems as described herein are considerable. For example, commuter time, particularly for passengers traveling extended distances, can be substantially reduced. Overcrowding on such conveyances can similarly be eliminated or substantially reduced over traditional systems. Specifically, if the average commute time is reduced, there are fewer passengers in the system at any one time. Electrical and other forms of energy and maintenance costs are thus reduced as there are far fewer inertial losses due to starting and stopping of rolling stock.

In accordance with a further aspect of the disclosure, the “express” train (or express loop, if desired) can be comprised of trains with substantially the same number of cars as the “local” trains. Computers preferably monitor and control frequency, speed, information and phasing of trains to insure the strategic coincidence of aligning trains. Moreover, any traveler who misses a transfer point can simply wait for the next opportunity to cross over to the other train. As will further be appreciated, such principles may be adapted, as desired, to surface road transport (e.g., buses), water transport, and the like.

In further accordance with the disclosure, a method and system for adaptation of existing subterranean (and surface) transit systems are provided, such as that of New York City. Specifically, the New York transit system, which was mostly built from the last decade of the 19th century through the first decade of the 20th century, was tunneled, largely under an existing city. Because of this, structural spans were minimized, and many single tunnels were used in groups of parallel tunnels. Wider passages and spaces were created, but almost always with columns separating individual tracks. Systems and methods are provided herein to adapt the advantages of the existing disclosure to such a tunnel infrastructure.

In accordance with still a further aspect of the disclosure, a system is provided for transportation that includes a vehicle that makes local stops, such as a train or a bus, wherein the vehicle includes an energy storage device, such as a flywheel or regenerative braking system attached to a battery, wherein kinetic energy of the vehicle is converted and stored by a mechanical or electromechanical means in the flywheel (or into batteries by the regenerative braking mechanism) when the vehicle brakes (such as to a stop) and then released when the vehicle increases in speed or starts from a dead stop to conserve energy. This feature may also be incorporated into the other systems described herein.

It is to be understood that both the foregoing general description and the following detailed description are exemplary and are intended to provide further explanation of the present disclosure. The accompanying drawings, which are incorporated in and constitute part of this specification, are included to illustrate and provide a further understanding of the methods and systems of the disclosure. Together with the description, the drawings serve to explain the principles of the disclosed embodiments.

### BRIEF DESCRIPTION OF THE DRAWINGS

FIG. 1 is a section through a subway tunnel of an exemplary express loop train showing an “express” train car utilizing traditional rails and carriages.

FIG. 2 is a section through an exemplary “local” train stopped at a station with traditional rails and carriages.

FIG. 3 is an exemplary section through an double width tunnel with an “express” train joined to a “local” train on traditional rails and carriages during the transfer phase of the illustrated system's process.

FIG. 4 is an exemplary section through a double width tunnel with an “express” train joined to a “local” train supported by Mag-Lev suspension and propelled by an exemplary linear induction propulsion system during the transfer phase of the system's process.

FIG. 5 is a plan view of full-width commuter train cars linked together during the transfer phase of the illustrated system's process.

FIG. 6 is an illustrative section through a typical New York City Transit System station showing a single tunnel and a standard R142 transit car as is used in New York City.

FIG. 7 is an illustrative section through a typical New York Transit System station showing a single tunnel and an exemplary narrow profile “local” train stopped at the station with an exemplary narrow profile “express” train by-passing it.

FIG. 8 is a section through a single tunnel between existing stations during the period of transfer using exemplary narrow profile cars.

FIG. 9 is a top plan view of two exemplary narrow profile trains, an “express” and a “local”, during the period of transfer.

FIG. 10 is an exemplary plan of a portion of a city illustrating an embodiment of a transportation loop system with stations as described herein.

### DETAILED DESCRIPTION OF THE PREFERRED EMBODIMENT

Reference will now be made in detail to the present preferred embodiments of the invention, examples of which are illustrated in the accompanying drawings. The methods and corresponding steps of the invention will be described in conjunction with the detailed description of the systems.

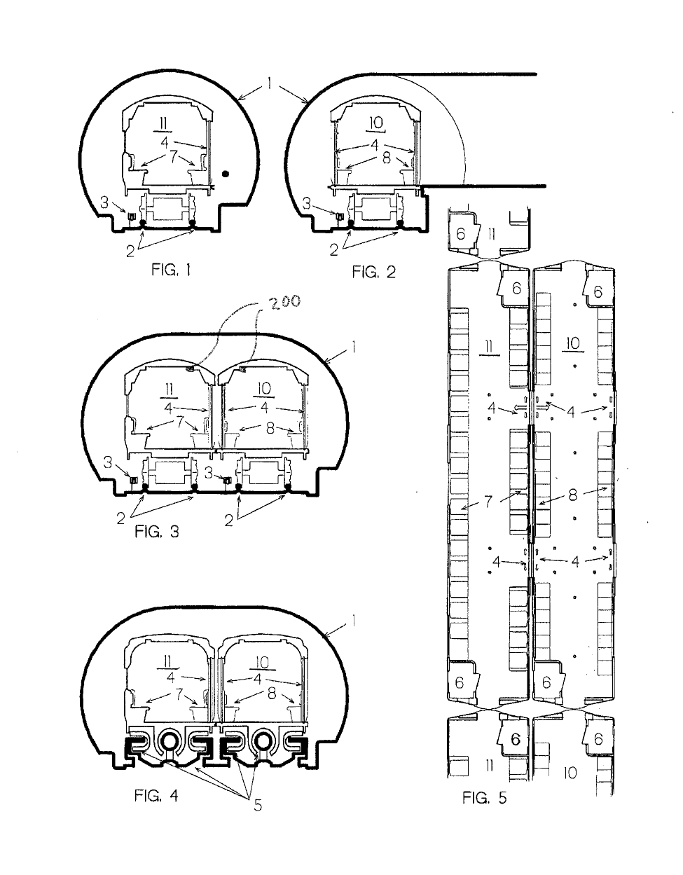

FIG. 1 is a section through a single tunnel including a tunnel wall 1 and a standard gauge track 2 with an express train 11 using typical motors, carriages and wheels. A “third rail” 3 is illustrated supplying electrical power to the express train 11. Doors 4 are provided that represent a means of boarding or exiting the express train 11, as well as a plurality of interconnections between the “express” and “local” train cars when connected. The express train 11 is provided with seats 7 that are preferably upholstered, contoured and reasonably comfortable, as the rider might occupy it for an extended period of time. Express train 11 preferably does not stop, except that it can be ordinarily be removed from the system for maintenance by being switched to a different track that can lead to a maintenance facility.

FIG. 2 illustrates a section through a single tunnel having a local train 10 disposed therein. The tunnel includes a wall 1 and station ceiling, as well as a standard track 2 and carriage and third rail 3. Local train 10 includes doors 4 at opposite sides of the car 10. In accordance with the particular illustrated embodiment, only doors on the station side are opened during the loading of passengers. In further accordance with the illustrated embodiment, the opposite doors are preferably only opened during transfer from the “local” train 10 to the “express” train 11. Seating 8 in the local train is preferably adapted and configured for shorter term use, since it is contemplated that users of the illustrated system will spend less time on local train 10 than on express train 11. It is further contemplated that many, if not most of the local car's 10 occupants are in a standing position to be ready for the transfer to the “express” car or to exit the train during a station stop.

FIG. 3 illustrates a section view through a double width transit tunnel having a wall 1, standard gauge track 2 and third rail segments 3. Such double width tunnels are typically not available in most urban centers, and thus the embodiment of FIG. 3 is best suited for a transit system that is to be newly constructed rather than retrofitted. Doors 4 in each train 10, 11 are aligned prior to coupling the trains 10, 11 together. As is clear from FIG. 3, trains 10, 11 are not yet coupled. In accordance with a different embodiment, FIG. 4 illustrates a section view through a double width transit tunnel similar to that of FIG. 3. However, a magnetic propulsion and suspension system 5 is illustrated rather than a conventional drive system.

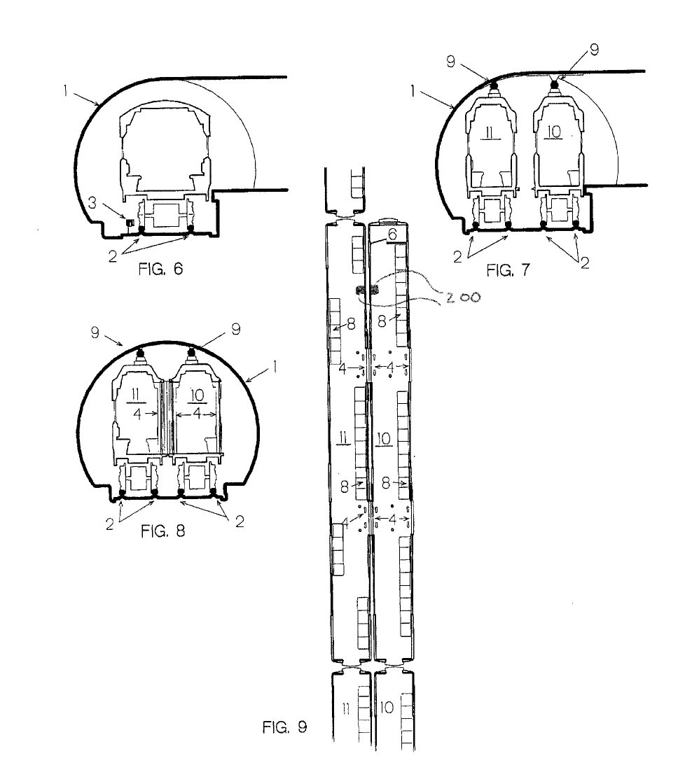

FIG. 5 illustrates a plan view of a “local” train 10 joined to an “express” train 11 for transfer of passengers while the trains are moving. As illustrate, a plurality of doors 4 are provided on both sides of the “local” train 10 and on one side of the “express” train 11. In the illustrated embodiment, no doors are present on the other side of car 11 in order to provide room for more seating 7. If desired, motorman houses 6 can be provided in one or more cars of each train, but need not be present if the system is fully computerized.

FIG. 6 is a section through a transit tunnel at a station as might be found in New York City or London. FIG. 6 depicts a standard R142 transit car on standard gauge rails 2, a carriage, and third rail 3.

By way of contrast, FIG. 7 illustrates the same tunnel location as FIG. 6 having a wall 1, except an exemplary narrow profile “express” train 11 is depicted bypassing a stopped narrow profile “local” train 10. Narrow gauge track 2 and carriages are provided in lieu of standard width track and carriages. Moreover, elevated (e.g., ceiling-mounted) rails 9 are also provided having power conductors and rollers, as desired, to stabilize the cars laterally, as the narrow gauge may tend to be less stable than standard gauges. Such elevated rails may be retrofitted onto elevated lines to support the narrower cars when exiting subway tunnels. FIG. 8 is an exemplary, illustrative section through a single tunnel as may be found in New York or London. An exemplary, narrow width “express” train 11 is shown joined to an exemplary, narrow width “local” train for passenger transfer.

FIG. 9 is a top plan view of an exemplary narrow profile “local” train 10 joined to an exemplary narrow profile “express” train 11, wherein each train includes a plurality of doors 4 for access from the station and for passenger transfer, and motorman's houses 6, if desired. The seats 8 are preferably of minimal projection into the space of the train car to provide as much aisle space as possible for movement of passengers and standing passengers.

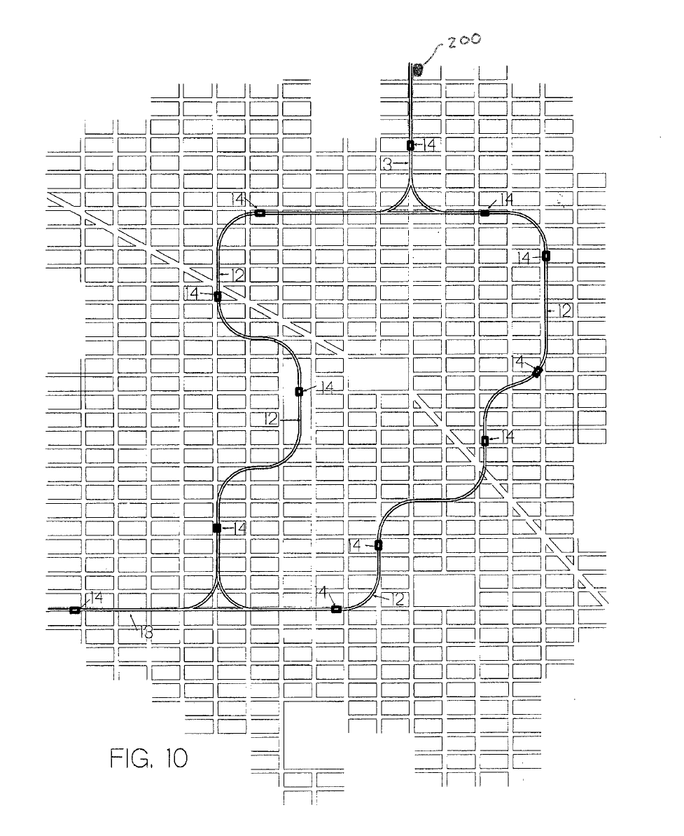

FIG. 10 is a partial view of a city with an exemplary mass transit subway loop including a center loop 12 and parts of an outer loop or spurs 13, as well as station locations 14. The track indicates a single direction “express” and “local” loop for small cities or a four track system with “express” and “local” loops going in both directions in larger cities.

The disclosure also provides a machine readable program on a computer readable medium containing instructions for controlling a system for mass transit as disclosed herein. The program is adapted and configured to control a controller (e.g., 200) for controlling the trains in the system to facilitate all necessary operations to permit alignment, coupling, the transfer of passengers and goods, and decoupling. Controller 200 can be located in one or both trains, or externally of the trains.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions of operations of the system herein are further intended to represent conceptual views of illustrative circuitry and software embodying various the principles of the invention. Thus the control of the various elements shown in the Figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent to those shown herein.

Similarly, it will be appreciated that the system flows described herein represent various processes which may be substantially represented in computer-readable medium and so executed by a computer or processor, whether or not such computer or processor is explicitly shown. Moreover, the various processes can be understood as representing not only processing and/or other functions but, alternatively, as blocks of program code that carry out such processing or functions.

The methods and systems of the present invention, as described above and shown in the drawings, provide for systems of mass transit with superior attributes that define a variety of improvements over previous systems. It will be apparent to those skilled in the art that various modifications and variations can be made in the devices and methods of the present disclosure without departing from the spirit or scope of the disclosure. Thus, it is intended that the present invention include modifications and variations that are within the scope of the subject disclosure and equivalents.

1. A transportation system, comprising:
a) a first train traveling on a first track having a first car with a first door for accessing the first car;
b) a second train traveling on a second track parallel to the first track having a second car with a second door for accessing the second car, and;
c) a controller for aligning the first and second doors when the first and second trains are traveling alongside one another and engaging the first train to the second train so that passengers or goods can be transferred between the trains while the trains are moving.

2. The system of claim 1, wherein the transit system is a mass transit system principally for transporting passengers.

3. The system of claim 1, wherein the first train engages the second train to permit transfer between the trains for a predetermined period of time.

4. The system of claim 1, wherein the first train is a local train and the second train is an express train.

5. The system of claim 4, wherein the second train travels in a continuous loop and generally does not stop.

6. The system of claim 1, wherein each of the first and second trains are on standard width track.

7. The system of claim 1, wherein the first and second trains are on tracks that have a narrower than standard width.

8. The system of claim 7, further comprising at least one overhead rail for engaging at least one of the first train and second train.

9. The system of claim 1, further comprising a machine readable program on a computer readable medium containing instructions for controlling the controller.

10. The system of claim 1, further comprising an energy storage device adapted and configured to store kinetic energy of at least one of the trains when said train decelerates.

11. The system of claim 10, wherein the energy storage device includes a regenerative braking system attached to a battery.

12. The system of claim 10, wherein the energy storage device includes a regenerative braking system attached to a battery.

13. The system of claim 10, wherein the energy storage device includes a flywheel.

14. A machine readable program on a computer readable medium containing instructions for controlling a system for mass transit, wherein the program includes:
a) a first computer code segment for controlling a first train traveling on a first track having a first car with a first door for accessing the first car;
b) a second computer code segment for controlling a second train traveling on a second track parallel to the first track having a second car with a second door for accessing the second car, and;
c) a third computer code segment for controlling a controller for aligning the first and second doors when the first and second trains are traveling alongside one another and engaging the first train to the second train so that passengers or goods can be transferred between the trains while the trains are moving.

15. The machine readable program of claim 14, wherein the program is adapted and configured to instruct the first train to engage the second train to permit transfer between the trains for a predetermined period of time.
